(19) United States
(12) Patent Application Publication
(10) Pub. No.: US 2025/0101259 A1
(43) Pub. Date: Mar. 27, 2025

(54) AQUEOUS EMULSIONS CONTAINING SHELLAC PARTICLES AND COATINGS FORMED THEREWITH

(71) Applicant: Michelman, Inc., Cincinnati, OH (US)

(72) Inventors: Tyler Alan REECE, Loveland, OH (US); Christopher MOST, Edgewood, KY (US); Becky McCLOSKEY, Loveland, OH (US); Qiaoqiao GAN, Shanghai (CN); Mark CLARK, Mason, OH (US); Hong ZHANG, Mason, OH (US)

(73) Assignee: Michelman, Inc., Cincinnati, OH (US)

(21) Appl. No.: 18/730,533

(22) PCT Filed: Jan. 26, 2023
(86) PCT No.: PCT/US2023/061398

§ 371 Date: Jul. 19, 2024

Related U.S. Application Data
(60) Provisional application No. 63/304,028, filed on Jan. 28, 2022.
(60) Provisional application No. 63/390,858, filed on Jul. 20, 2022.

(51) Int. Cl. C09D 199/00; A01C 1/06; C09D 5/02; C09D 7/65

(52) U.S. Cl. CPC C09D 199/00; A01C 1/06; C09D 5/022; C09D 7/65

(57) ABSTRACT

Coatings may be used to discourage agglomeration and dust formation when handling seeds. Aqueous emulsions suitable for coating seeds and other substrates may comprise an aqueous fluid, a film-forming polymer that is water-soluble or biodegradable, optionally, a plasticizer, and shellac particles dispersed in solid form in the aqueous fluid. The film-forming polymer is at least partially dissolved in the aqueous fluid. Optionally, the aqueous emulsions may comprise at least one effect pigment, and/or at least one wax, and/or one or more of at least one surfactant, at least one biocide, at least one preservative, at least one second film-forming polymer, at least one crosslinking agent, or any combination thereof.

### BACKGROUND

Dust formation can be problematic in a number of industries, with consequences of dust formation ranging from mere nuisance to severe health and safety hazards. Uke many small particles, dust represents a potential inhalation hazard that may lead to adverse health effects, and under certain circumstances fine dust particles may be subject to flash ignition.

Handling and planting of seeds represents one area where dust formation may be problematic. For example, seed sowing equipment may lead to dust drift. Seeds may also be inherently prone to dust formation, since they may be small particles or contain small particles. Dust drift, also referred to as dust off, is a measure of the loss of particles from seeds when the seeds are handled. High dust off values are representative of excessive dust formation. Excessive dust off may liberate active ingredients from seeds or a coating thereon, such as fertilizers or herbicides, and thus impact crop growing efficacy. Moreover, studies have shown that excess dust formation during seed planting may have negative environmental impacts, such as having a deleterious effect on local honey bee populations.

Another issue commonly encountered when using seed sowing equipment is that of flowability, which refers to the ease with which dry seeds slide through internals of the seed sowing equipment. Low flowability values may lead to issues such as, for example, clumping of the seeds (sometimes referred to in the art as “bridging”), plugging of the seed sowing equipment in various locations, inconsistent seed flow through the seed sowing equipment, and uneven planting of the seeds, including placement of multiple seeds per hole or missing seeds in some holes. All of these factors may lead to inconsistent or sub-optimal planting of a given plot of farmland and, in turn, an undesired drop in crop yield.

To discourage the formation of dust and to encourage ready flowability, coatings are frequently applied to seeds, as well as to other types of substances that are prone to dust formation. Polymer coatings are frequently utilized for this purpose. Although polymer coatings may suppress dust formation and promote increased flowability in some cases, many polymer coatings are not readily dissolvable or biodegradable and thus may persist as microplastics in the environment for extended periods of time. Indeed, the environmental issues associated with microplastics are so impactful, the European Union has mandated a phase out of seed coatings capable of generating microplastics by the mid-2020s, and it is expected that other countries may follow suit in the coming years.

As a further issue, many coatings are unable to deliver satisfactory dust off and flow performance in combination with one another, especially those that extensively utilize bio-sourced or biodegradable materials. Many conventional bio-sourced components for seed coatings and other types of coatings are experiencing ongoing supply chain issues or may deliver coating performance that is less than desired. Thus, there is a desire to render coatings for seeds and other surfaces more readily biodegradable by utilizing higher percentages of (or exclusively) bio-sourced materials that are easily sourced while concurrently realizing coatings having exceptional performance for their intended application.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to one having ordinary skill in the art and having the benefit of this disclosure.

FIG. 1 is a diagram of an illustrative system for coating seeds using a drum coater according to various embodiments of the present disclosure.

FIG. 2 is a plot of dry flow performance of seeds coated using the aqueous emulsions of Samples 1-4.

FIG. 3 is a plot of Heubach dust off performance of seeds coated using the aqueous emulsions of Samples 1-4.

FIG. 4 is a plot of dry flow performance of seeds coated using the aqueous emulsions of Samples 5-8.

FIG. 5 is a plot of Heubach dust off performance of seeds coated using the aqueous emulsions of Samples 5-8.

FIG. 6 is a plot of dry flow performance of seeds coated using the aqueous emulsions of Samples 9 and 10.

FIG. 7 is a plot of Heubach dust off performance of seeds coated using the aqueous emulsions of Samples 9 and 10.

FIG. 8 is a graph of average penetration depth for various types of wax in comparison to shellac particles.

FIG. 9 is a graph of coefficient of friction for various types of coatings in comparison to coatings containing shellac particles of various sizes.

FIG. 10 is a graph of dry flow performance of seeds coated with conventional wax coatings in comparison to seeds coated with coatings containing shellac particles of various sizes.

FIG. 11 is a plot of Heubach dust off performance of seeds coated with conventional wax coatings in comparison to seeds coated with coatings containing shellac particles of various sizes.

### DETAILED DESCRIPTION

The present disclosure generally relates to emulsion and coating technologies and, more specifically, aqueous emulsions and coatings formed therefrom that may lack microplastic-generating components.

As discussed above, dust formation may be problematic in various respects, including when handling and planting seeds. Polymer-containing seed coatings and other types of polymer coatings may promote ready flowability and suppress dust formation to varying degrees, but many types of such polymer coatings may be based on chemistries or technologies that render them as microplastics. As used herein, the term “microplastics” refers to polymer particles having a maximum size of about 5 mm in any dimension, wherein the polymer is non-biopolymer in nature (i.e., not naturally occurring), water-insoluble and non-biodegradable. Because microplastics are a growing environmental concern, polymer coatings that are defined as microplastics are currently being phased out. At present, there are few viable alternatives for suppressing dust formation and promoting ready flowability when forming coatings upon seeds and other types of surfaces, particularly using microplastics-free compositions.

The present disclosure provides aqueous emulsions and coatings formed therefrom that may incorporate polymers that are 1) water-soluble or biodegradable synthetic polymers, and/or 2) naturally occurring biopolymers, preferably without further chemical modifications, which need not necessarily be water-soluble or biodegradable. In the disclosure herein, a material is considered to be water-soluble if the material has an aqueous solubility of about 2 g/L or greater at room temperature. Biodegradation may be established by OECD test method 301D. Other standard test methods for determining biodegradation include OECD test methods 301B, C, or F or OECD test method 310. In either case, the aqueous emulsions and coatings are not substantially based on chemistries that are defined as microplastics and may persist in the environment for extended periods of time. Advantageously, the aqueous emulsions may incorporate other biologically sourced materials (including all biologically sourced materials in some instances) that maintain the environmental favorability and also promote formation of robust polymer coatings when the aqueous emulsions have dried upon various types of surfaces. In some embodiments, the aqueous emulsions may be microplastics-free and afford coatings that are likewise microplastics-free.

Advantageously, coatings formed from the aqueous emulsions of the present disclosure may also suppress dust formation and promote ready flowability when incorporated as a coating upon various types of seeds. Performance of the coatings in these respects may be at least comparable to common coating materials that contain microplastics. As such, the aqueous emulsions of the present disclosure and coatings formed therefrom represent a potentially disruptive technology for formation of seed coatings and other types of coatings. Because naturally occurring biopolymers are employed in the aqueous emulsions and coatings disclosed herein, they are more environmentally sustainable and renewable than are present technologies. Although the aqueous emulsions of the present disclosure may be particularly advantageous for coating seeds, it is to be appreciated that the aqueous emulsions may be suitable for forming coatings upon other types of substrates as well.

The aqueous emulsions described herein may be formulated in several different ways, embodiments of which may comprise shellac in combination with a polymer that is water-soluble or biodegradable, any of which may be optionally in further combination with a wax emulsified as solids in the aqueous fluid (e.g., as a plurality of solid particles dispersed in the aqueous fluid). The wax may comprise one or more waxes, and the polymer may comprise one or more polymers. The polymer may promote emulsification, sometimes in the absence of other emulsifying agents or surfactants. In addition, the polymer may define a continuous phase once the aqueous emulsion has been deposited as a coating and dried. The wax particles, if present, may define a discontinuous phase distributed within the continuous phase of the coating.

In the present disclosure, the shellac may be in the form of small particles that is dispersed as a solid in the aqueous fluid, such that the shellac constitutes a discontinuous phase within the aqueous emulsions and coatings formed therefrom. When the shellac is present in the form of small particles, wax particles may be optionally omitted from the aqueous emulsions and coatings formed therefrom. Again, the wax may comprise one or more waxes, and the polymer may comprise one or more polymers. When the shellac is in the form of small particles, the aqueous emulsions may have a discontinuous phase comprising the shellac particles (and optional wax particles) emulsified in an aqueous fluid and a continuous phase comprising the polymer that is water-soluble and/or biodegradable, in which the polymer is at least partially dissolved in the aqueous fluid. In this case, the aqueous emulsions may be referred to equivalently as aqueous dispersions or aqueous shellac dispersions. Aqueous shellac dispersions lacking a polymer are also possible, provided that a surfactant is present that is suitable for forming shellac particles and maintaining the shellac particles dispersed in an aqueous phase. Once deposited as a coating, the shellac particles may remain distributed throughout the coating, but with discontinuities existing between individual shellac particles. That is, the shellac particles and the optional wax particles may define a discontinuous phase within the coating, even though the shellac particles and optional wax particles may be distributed substantially uniformly throughout the coating. The polymer, if present, may define a continuous phase within the coating, and the shellac particles and optional wax particles may define a discontinuous phase within the continuous phase defined by the polymer.

Aqueous emulsions (aqueous shellac dispersions) containing small particles of shellac may be advantageous in various respects to aqueous emulsions containing at least partially dissolved shellac. Since such aqueous emulsions may omit synthetic waxes, they may be desirable in view of increasingly strict mandates to limit synthetic materials in various products. Moreover, by limiting or omitting naturally sourced waxes (or synthetic waxes), such aqueous emulsions may alleviate supply chain and cost issues associated with these types of waxes. Performance comparable to or exceeding that of wax coatings may be realized with coatings containing shellac particles that define a discontinuous phase within a coating, as specified in the disclosure herein. While aqueous emulsions containing shellac particles may suitably omit waxes of various types, it is to be appreciated, however, that one or more waxes (e.g., wax particles) may be present in the aqueous emulsions to improve lubricity or other properties, if desired, provided that government regulations or other considerations do not preclude the use of a wax in a given application.

Thus, in some embodiments, aqueous emulsions of the present disclosure may comprise: an aqueous fluid, a wax, and a polymer blend comprising shellac, a film-forming polymer that is water-soluble or biodegradable, and, optionally, a plasticizer. That is, the plasticizer may or may not be present in the aqueous emulsions and coatings formed therefrom. Advantaged performance may be realized when the plasticizer is present, but the coating performance still remains acceptable even when the plasticizer is not present. The wax and the polymer blend are dispersed in the aqueous fluid. As used herein, the term “dispersed” refers to a substance being dissolved as a solution or being suspended as small particles in an emulsion. As such, the aqueous emulsions described herein may be considered to be synonymous with the term “aqueous dispersion of wax particles.” Preferably, the wax may be dispersed by being emulsified as solids in the aqueous fluid and the polymer blend (i.e., the shellac, the first film-forming polymer, and the optional plasticizer) may be dispersed by being at least partially dissolved in the aqueous fluid. In such aqueous emulsions, the polymer and the shellac may define a continuous phase once deposited together within a coating, and the wax particles may define a discontinuous phase within the coating. The wax and the plasticizer (if present) may also be biologically sourced, as discussed in additional detail below. Advantageously, the plasticizer (if present) and the shellac may interact to produce a robust coating. Coatings lacking the plasticizer tend to be more brittle, but they may still afford acceptable performance in some cases.

In other embodiments, aqueous emulsions of the present disclosure may contain the shellac dispersed in the form of shellac particles within the aqueous phase to define the emulsion, in which a wax may or may not also be present. More specifically, such aqueous emulsions may comprise an aqueous fluid; a film-forming polymer that is water-soluble or biodegradable; optionally, a plasticizer; and shellac particles dispersed in solid form in the aqueous fluid. The film-forming polymer may be at least partially dissolved in the aqueous fluid in the foregoing aqueous emulsions, which may optionally further comprise a wax particles dispersed in the aqueous fluid in combination with the shellac particles.

In some examples, the shellac particles may be produced through precipitation of dissolved shellac in the presence of the film-forming polymer and/or a surfactant capable of promoting formation of the shellac particles. The film-forming polymer, examples of which are provided below, may further aid in emulsifying the shellac particles within the aqueous emulsions. Other surfactants and emulsifiers may be present as well, if needed to promote formation and/or emulsification of the shellac particles. Surprisingly, the shellac particles may function similarly to conventional waxes utilized in coatings of various types.

Accordingly, in some embodiments, aqueous emulsions of the present disclosure may comprise: an aqueous fluid, a film-forming polymer that is water-soluble or biodegradable, optionally, a plasticizer, and shellac particles dispersed in solid form in the aqueous fluid. The film-forming polymer may be at least partially dissolved as a solution in the aqueous fluid. Optionally, the aqueous emulsions may further comprise wax particles dispersed as solids in the aqueous phase.

Aqueous fluids suitable for use in the present disclosure may comprise water or water admixed with a water-miscible organic solvent, such as an alcohol or a glycol. Such water-miscible organic solvents may sometimes be present as an anti-freeze agent by lowering the freezing point of the aqueous fluid. The aqueous fluids and polymer emulsions may be acidic, neutral, or basic, depending upon particular application needs. A particular pH may be chosen to maintain the emulsion in emulsified form or to afford a particular protonation state for one or more components of the emulsion, for example. Buffering may be conducted, if needed or desired. As such, the aqueous fluids and aqueous emulsions formed therefrom may have a pH ranging from about 1 to about 7, or about 2 to about 6, or about 1 to about 6, or about 6 to about 7, or about 6 to about 8, or about 7 to about 8, or about 7 to about 14, or about 8 to about 14, or about 8 to about 12, or about 7 to about 9.

The aqueous fluid may be present in the aqueous emulsions described herein in an amount up to about 80 wt. %, or up to about 70 wt. %, or up to about 60 wt. %, or up to about 50 wt. %, or up to about 40 wt. %, or up to about 30 wt. %, or up to about 20 wt. %, such as about 5 wt. % to about 20 wt. %, or about 10 wt. % to about 25 wt. %, or about 10 wt. % to about 30 wt. %, or about 30 wt. % to about 50 wt. %, or about 50 wt. % to about 70 wt. %, or about 60 wt. % to about 80 wt. %, or about 50 wt. % to about 80 wt. %, each as measured based on total mass of the aqueous emulsions.

The aqueous emulsions described herein may contain a high loading of total solids, some of which may be at least partially dissolved in the aqueous fluid and some of which may be dispersed as solids in the aqueous fluids. As used herein, the term “solids” refers to any non-liquid component dispersed within a given aqueous fluid, either in an at least partially dissolved form or in a particulate (undissolved/emulsified/dispersed form). For instance, in non-limiting examples, shellac particles and wax particles (if present) may be dispersed as solids in the aqueous fluids and the film-forming polymer may be at least partially dissolved in the aqueous fluid in the aqueous emulsions disclosed herein.

In illustrative embodiments, the aqueous emulsions described herein may contain about 5 wt. % to about 60 wt. % total solids, or about 10 wt. % to about 60 wt. % total solids, or about 15 wt. % to about 55 wt. % total solids, or about 20 wt. % to about 50 wt. % total solids, or about 35 wt. % to about 55 wt. % total solids, based on total mass of the aqueous emulsions. Total solids refer to both dissolved solids and emulsified solids, including dispersed solids. The aqueous fluid may constitute the balance of mass within the aqueous emulsions. Solids present in particulate form (emulsified solids) may be present in particle sizes ranging from about 50 nm to about 1 mm in size, or about 50 nm to about 5 μm in size, or about 100 nm to about 5 μm in size, for example, within the aqueous emulsions described herein.

Waxes are hydrophobic organic substances that occur in petroleum and other oleaginous materials, are biosynthesized by plants and animals, or are obtained synthetically. Waxes are usually malleable solids at room temperature and may comprise one or more higher alkanes (paraffins), particularly normal or branched C₁₆-C₁₀₀ alkanes or C₂₀-C₅₀ alkanes, lipids and/or oils. Suitable waxes for use in the disclosure herein may include, but are not limited to, paraffin waxes, oxidized paraffin waxes, polyolefin waxes, oxidized polyolefin waxes, natural waxes, oxidized natural waxes, and any combination thereof. In addition, waxy components obtained from de-waxed shellac (i.e., shellac wax) may be present in the aqueous emulsions disclosed herein, particularly when shellac particles are present in the aqueous emulsions, either with or without other waxes being present. As used herein, a wax is considered “oxidized” if oxygenated functional groups such as alcohols, carboxylic acids, epoxides or the like are introduced to an otherwise unsubstituted (paraffinic) hydrocarbon backbone. The amount of oxygenated functional groups introduced to a particular wax may, for example, be sufficient to lower the hydrophobicity of the wax to an extent necessary to facilitate formation of an emulsified form of the wax.

If used, specific examples of suitable paraffin waxes and lipidic waxes for use in the disclosure herein may include, but are not limited to, slack wax, beeswax, hydrogenated lipids, refined wax, semi-refined wax, scale wax, microcrystalline wax, beeswax, vegetable-based waxes such as soy and palm waxes, carnauba wax, rice bran wax, montan ester wax, sugar cane wax, sunflower wax, shellac wax, hydrogenated castor oil, poly(3-hydrobuyrate-co-3-hydroxyvalerate), synthetic waxes such as oligomer waxes derived from linear alpha olefins or copolymers thereof, Fischer-Tropsch waxes, polyolefin waxes (e.g., polyethylene wax or polypropylene wax), and any combination thereof. Suitable waxes may be sourced as a wax emulsion in an aqueous fluid, which may then be further formulated with a polymer or polymer blend to form the aqueous emulsions described herein. Examples of wax emulsions that may be used in the disclosure herein include, but are not limited to, MICHEM® Emulsions such as ME62330, ME93335, ME61335, ME52137, and ME24414 (Michelman). Particularly suitable waxes for use in the disclosure herein may be obtained from a biological source, such as any plant- or animal-based wax listed above, and which is also biodegradable. Thus, in particular embodiments, the wax may comprise at least one biodegradable wax in the disclosure herein, such as carnauba wax, for instance. It is to be appreciated, however, that some synthetic waxes, such as certain Fischer-Tropsch waxes, also allow microplastics-free formulations to be maintained and may similarly be suitable for use in the disclosure herein.

If used, suitable waxes for incorporation within the aqueous emulsions of the present disclosure may have a melting point of about 50° C. or above and have an average diameter, when emulsified, ranging up to about 50,000 nm (50 microns) in size, such as about 300 nm or less, or about 200 nm or less, or about 100 nm or less, preferably an average diameter ranging from about 10 nm to about 100 nm, or about 25 nm to about 50 nm, or about 50 nm to about 90 nm, or about 20 nm to about 75 nm.

If used, waxes may be present in the aqueous emulsions described herein in an amount up to about 60 wt. %, or up to about 50 wt. %, or up to about 40 wt. %, or up to about 30 wt. %, such as about 5 wt. % to about 40 wt. %, or about 15 wt. % to about 35 wt. %, or about 20 wt. % to about 30 wt. %, as measured based on the mass of total solids within the aqueous emulsions. The aqueous emulsions may also be devoid of wax. For example, when the aqueous emulsions contain shellac particles, the aqueous emulsions may optionally lack a wax (i.e., be “wax-free”). Aqueous emulsions containing shellac that is at least partially dissolved in the aqueous fluid may contain wax within any of the foregoing compositional ranges.

The term “shellac” refers to a resinous material obtained from secretions of the female lac bug and comprising oligomers of at least aleuritic acid and shellolic acid. Shellacs suitable for use in the present disclosure may, depending on source and the season of harvest, vary in color and aleuritic acid/shellolic acid ratio. Shellacs may be added to the aqueous fluid or polymer blend when dissolved in a suitable organic solvent, such as ethyl alcohol, or finely ground or precipitated shellac particles may be blended with an aqueous fluid or polymer blend to form the aqueous emulsions described herein. In still another alternative, the acidic groups in the shellac may be at least partially neutralized with aqueous ammonia, an amine (e.g., ethanolamine, triethanolamine, trimethylamine, diethylamine, dimethylethylamine, triethylamine, and the like), or alkali metal base (e.g., NaOH, KOH, or the like), and the resulting neutralized shellac may be combined as an aqueous solution or suspension when forming the aqueous emulsions described herein. If less than complete neutralization occurs, the shellac may be ionomeric (i.e., contain both positive and negatively charged groups). If an amine is used to perform the neutralization and excess amine remains present, the excess amine may react with epoxide groups in the film-forming polymer, if present, to promote crosslinking within a coating formed from the aqueous emulsions. Thus, when neutralized or partially neutralized shellac is present within an aqueous fluid (e.g., within a neutral or alkaline medium), the shellac in the aqueous emulsions disclosed herein may bear one or more ionic charges. The shellac bearing one or more ionic charges may be at least partially dissolved in the aqueous fluid of the aqueous emulsions, or shellac particles dispersed as solids in the aqueous emulsions may bear one or more ionic charged while remaining at least partially undissolved therein. A combination of dissolved shellac and shellac particles may be present in the aqueous emulsions in some instances.

In some embodiments, the shellac may be present as shellac particles in the aqueous emulsions disclosed herein, sometimes without a synthetic wax or other type of wax also being present. Shellac particles may be formed by dissolving shellac from a specified source under alkaline conditions to provide an alkaline aqueous shellac solution, as described above. Any of ammonia, amines, or alkali metal bases may be used to form the alkaline aqueous shellac solution. The alkaline aqueous shellac solution may then be acidified to afford shellac particles. The shellac particles may be ionomeric in some instances, should incomplete re-protonation of the acidic groups take place. Suitable acids for acidifying the alkaline aqueous shellac solution are not believed to be particularly limited. Illustrative acids that may be suitable include mineral acids like hydrochloric acid and organic acids like acetic acid, lactic acid, or citric acid, for instance. The concentration of organic acids used to promote precipitation of the shellac particles may range from about 10 wt. % to about 60 wt. %, or about 25 wt. % to about 60 wt. %, or about 40 wt. % to about 60 wt. %. Alternately, the organic acid may be delivered neat to the alkaline aqueous phase to promote precipitation of shellac particles. The amount of acid combined with the alkaline aqueous shellac solution may be determined by the pH at which precipitation of the shellac particles begins to occur, the temperature of the alkaline aqueous solution, and the rate at which the acid is combined with alkaline aqueous shellac solution, both of which may impact the size of the shellac particles that are obtained. The concentration of the shellac within the alkaline aqueous shellac solution may impact the shellac particle size as well. Further details regarding production of shellac particles in the foregoing manner may be found in U.S. Pat. No. 5,567,438, which is incorporated herein by reference.

When produced through acidification, the shellac particles may form at a pH of about 8 or below, or about 7.5 or below, or about 7 or below, or about 6.5 or below, or about 6 or below, such as within a pH of about 6 to about 8, or about 5 to about 7.5. If desired, the pH of the aqueous phase may be further lowered after formation of the shellac particles has taken place. For example, the pH may be lowered below the pH at which precipitation takes place in order to limit re-dissolution of the shellac particles during heating to form the aqueous emulsions described herein. Thus, in some embodiments, the aqueous phase containing the shellac particles may have a pH within about of about 6 to about 8, or about 7 to about 8, or about 5 to about 7.5, or about 3 to about 7.

In alternate embodiments, an alkaline aqueous solution formed with a volatile base, such as ammonia or a low molecular weight amine, may be concentrated and/or heated to raise the shellac above the solubility limit and/or drive off at least a portion of the volatile base, in which case shellac particles may form without acidification taking place. Shellac particles formed in the foregoing manner may be ionomeric. Thus, in some embodiments, shellac particles need not necessarily be fully or partially protonated in the aqueous emulsions described herein.

In some embodiments, shellac particles may be formed in the presence of the film-forming polymer. For example, a suitable acid may be added to a solution containing dissolved shellac and the film-forming polymer, in which the film-forming polymer may capture the shellac particles as they form, thereby aiding in forming the aqueous emulsion. Alternately, shellac particle formation may take place by heating and/or concentrating an alkaline aqueous solution also containing the film-forming polymer to form shellac particles without acidification taking place, provided that a suitable surfactant or polymer is present for dispersing the shellac particles as they form. Again, shellac particles formed in the foregoing manner may be ionomeric. In still another example, shellac particles may be formed upon acidifying an aqueous solution in the presence of a suitable surfactant but without the film-forming polymer being present.

In non-limiting examples, suitable shellac particles may have an average particle size ranging from about 50 nm to about 50 μm (50,000 nm), or about 50 nm to about 5000 nm, or about 50 nm to about 250 nm, or about 100 nm to about 500 nm, or about 500 nm to about 3000 nm, or about 500 nm to about 1000 nm, or about 1000 nm to about 4000 nm, or about 2500 nm to about 5000 nm. Depending on the size of the shellac particles, coatings formed from the aqueous emulsions of the present disclosure may exhibit various properties. For example, smaller shellac particles around 100 nm or smaller in size may afford coatings exhibiting optical clarity, whereas larger shellac particles in the 2000-3000 nm or larger size range may be optically opaque.

Shellac is available in various grades depending on how purified it is and how dewaxed it is. Less dewaxed shellac is more difficult to disperse in water, although it is still possible to form particles. Less purified shellac can result in a darker color. The degree of dewaxing versus purification comes down to acid value and how easily the shellac is dispersed in water. Blonde is a variant of orange shellac with much of the natural shellac dye removed mechanically by filtering with activated carbon. While other grades are bleached chemically (e.g., using sodium hypochlorite) and chemically dissolved in caustic solution (e.g., using sodium carbonate), super blonde or ultra blonde shellac can be quite light colored and more water resistant. Button lac and seed lac are additional shellac grades of shellac that are commonly encountered and may be used herein. Even stick lac, the crudest grade of shellac, may be utilized herein. Any grade of shellac in dewaxed or non-dewaxed form may be suitable for use in the disclosure herein.

In more specific embodiments, the shellac utilized in the aqueous emulsions and coatings formed therefrom may be an at least partially dewaxed shellac, which may include a fully dewaxed shellac. When forming shellac particles, the shellac may be at least partially dewaxed prior to forming an alkaline aqueous shellac solution (or dewaxing may occur concurrently with forming an alkaline aqueous shellac solution), with the resulting shellac particles being obtained in dewaxed form following acidification of the alkaline aqueous shellac solution.

The waxy residue obtained following dewaxing of shellac (shellac wax) may be combined with the aqueous emulsions disclosed herein, according to some embodiments. In some embodiments, shellac wax may be utilized as a wax source, optionally in further combination with one or more additional waxes, in aqueous emulsions containing shellac dispersed in a dissolved form or as dispersed solid particles therein. The shellac in such aqueous emulsions may be at least partially dewaxed shellac or non-dewaxed shellac. In other embodiments, shellac wax, if used, may be present in the aqueous emulsions in combination with shellac particles, optionally in further combination with one or more additional waxes.

In either dissolved or dispersed shellac particle form, shellac may be present in the aqueous emulsions described herein in an amount up to about 90 wt. %, or up to about 80 wt. %, or up to about 70 wt. %, or up to about 60 wt. %, or up to about 50 wt. %, or up to about 40 wt. %, or up to about 30 wt. %, or up to about 25 wt. %, or up to about 20 wt. %, such as about 20 wt. % to about 90 wt. %, or about 20 wt. % to about 50 wt. %, or about 30 wt. % to about 70 wt. %, or about 40 wt. % to about 60 wt. %, or about 40 wt. % to about 70 wt. %, or about 1 wt. % to about 25 wt. %, or about 5 wt. % to about 15 wt. %, or about 10 wt. % to about 20 wt. %, or about 15 wt. % to about 30 wt. %, or about 15 wt. % to about 25 wt. %, or about 15 wt. % to about 35 wt. %, or about 20 wt. % to about 40 wt. %, as measured based on the mass of total solids within the aqueous emulsions. Preferably, the foregoing compositional ranges for shellac represent an amount of shellac particles dispersed in solid form in the aqueous emulsions disclosed herein.

Suitable film-forming polymers may include any polymer that promotes formation of a continuous thin film of substantially uniform thickness once a polymer emulsion of the present disclosure is introduced upon a surface and subsequently dried. Biodegradability of a film-forming polymer may be evaluated by OECD test method 301D. Other standard test methods that may be suitable for determining biodegradation include OECD test methods 301B, C, or F or OECD test method 310. Film-forming polymers suitable for use in the present disclosure may be natural or synthetic in origin. Suitable film-forming polymers may also promote emulsification of shellac particles, shellac wax particles (if present) and/or other wax particles (if present), optionally aided by other emulsifiers or surfactants, if needed.

Examples of suitable synthetic film-forming polymers exhibiting water solubility and/or biodegradability may include, but are not limited to, a polyethylene glycol, a polyvinyl pyrrolidone, a polyvinyl alcohol, a poly(meth)acrylic acid, a polylactic acid, a polyglycolic acid, a polysaccharide, any copolymer thereof, or any combination thereof. Suitable copolymers may include any copolymer that permits the parent polymer to maintain water solubility and/or biodegradability, while still promoting effective film formation. Although poly(meth)acrylic acid may be considered to constitute a microplastic in some jurisdictions, this polymer may be used in aqueous emulsions and coatings where a microplastics-free standard need not necessarily be maintained, or a suitable co-monomer may be introduced into poly(meth)acrylic acid to promote water solubility or biodegradability. In more particular embodiments, the film-forming polymer may comprise at least a polyvinyl alcohol. Polyvinyl alcohol and similar polymers may be desirable, in addition to its water solubility, since this polymer may promote at least partial emulsification of other components within the aqueous emulsions disclosed herein.

The film-forming polymer (or multiple film-forming polymers) may be present in the aqueous emulsions described herein in an amount up to about 60 wt. %, or up to about 50 wt. %, or up to about 40 wt. %, or up to about 30 wt. %, or up to about 20 wt. %, or up to about 15 wt. %, or up to about 10 wt. %, or up to about 5 wt. %, such as about 10 wt. % to about 60 wt. %, or about 20 wt. % to about 50 wt. %, or about 20 wt. % to about 60 wt. %, or about 30 wt. % to about 50 wt. %, or about 5 wt. % to about 25 wt. %, or about 10 wt. % to about 40 wt. %, or about 1 wt. % to about 5 wt. %, or about 2 wt. % to about 8 wt. %, or about 5 wt. % to about 12 wt. %, or about 10 wt. % to about 20 wt. %, as measured based on the mass of total solids within the aqueous emulsions.

Optionally, the aqueous emulsions may further comprise a second film-forming polymer different than the other film-forming polymer, which may be a synthetic polymer that is water-insoluble and/or non-biodegradable in particular examples. However, in order to meet a microplastics-free standard, the second film-forming polymer may also be a synthetic polymer that is water-soluble or biodegradable as well. Suitable examples of the second film-forming polymer are not believed to be particularly limited, other than having the capability for being distributed as emulsified particles in an aqueous emulsion of the present disclosure, optionally being water-soluble and/or biodegradable as well to maintain a microplastic-free profile. In more specific examples, the second film-forming polymer may comprise a polyvinyl acetate polymer or copolymer, such as a polyvinyl pyrrolidone-co-vinyl acetate copolymer (polyvinylpyrrolidone-co-polyvinylacetate). Polyvinyl acetate polymers and copolymers, such as polyvinyl pyrrolidone-co-vinyl acetate copolymer, may be desirable for meeting a microplastics-free standard due to its water solubility, although other biodegradable or water-soluble second film-forming polymers may also be suitable in this regard.

The second film-forming polymer may be present in the aqueous emulsions in an amount that is equal to or less than the amount of the other (first) film-forming polymer, such as polyvinyl alcohol. In more specific examples, the second film-forming polymer may be present in an amount up to about 20 wt. %, or up to about 10 wt. %, or up to about 7.5 wt. %, or up to about 5 wt. %, or up to about 2.5 wt. %, such as about 1 wt. % to about 5 wt. %, or about 2 wt. % to about 8 wt. %, or about 2.5 wt. % to about 5 wt. %, or about 4 wt. % to about 10 wt. %, or about 8 wt. % to about 20 wt. %, as measured based on the mass of total solids within the aqueous emulsions.

Other examples of suitable second film-forming polymers may include those that are commonly used in seed coatings, such as those described in U.S. Pat. No. 10,407,586, incorporated herein by reference. Such film-forming polymers may comprise a copolymer of ethylene and at least one co-monomer such as acrylic acid or derivatives thereof. Again, it is to be emphasized that the second film-forming polymer may be selected such that the aqueous emulsions and coatings formed therefrom either contain microplastics or remain microplastics-free, depending upon whether a particular second film-forming polymer is water-soluble and/or biodegradable and whether a microplastics-free coating is needed for a given application. Any of the following polymers may be functionalized, if needed, to promote water solubility or biodegradability and/or incorporate one or more additional co-monomers to promote water solubility or biodegradability. Moreover, when the aqueous emulsions are being utilized for forming coatings upon surfaces other than seeds (e.g., paper, cardboard, wood, metal (e.g., metal cans) or other types of substrates), other types of second film-forming polymers may be suitable, particularly if a microplastics-free coating is not required to be present.

Still other examples of suitable second film-forming polymers may include one or more polymers comprising at least one acrylate monomer, more particularly at least one acrylate ester. Acrylate monomers may include (meth)acrylate esters, (meth)acrylamides, amine-functionalized (meth)acrylate monomers, polyether-functionalized (meth)acrylate monomers, and the like. Specific examples of suitable acrylate monomers may include, for example, n-butyl (meth)acrylate, isobutyl (meth)acrylate, methyl (meth)acrylate, ethyl (meth)acrylate, 2-ethylhexyl (meth)acrylate, and cycloalkyl (meth)acrylates such as isobornyl (meth)acrylate and cyclohexyl (meth)acrylate, and (meth)acrylamide. Other suitable acrylate monomers may include, for example, hydroxy-functionalized (meth)acrylate monomers such as hydroxyethyl (meth)acrylate and hydroxylpropyl (meth)acrylate; (meth)acrylamide derivatives such as N-methylol (meth)acrylamide and diacetone (meth)acrylamide; diallyl (meth)acrylate and various alkylene glycol di(meth)acrylates. Still other suitable acrylate monomers may include those comprising at least one amine group (e.g., a primary amine, a secondary amine or a tertiary amine) such as, for example, 2-(dimethylamino)ethyl (meth)acrylate, 3-(dimethylamino)propyl (meth)acrylate, 2-(diethylamino)ethyl (meth)acrylate, 3-(diethylamino)propyl (meth)acrylate, 2-(ethylamino)ethyl (meth)acrylate, 3-(ethylamino)propyl (meth)acrylate, 2-(methylamino)ethyl (meth)acrylate, 3-(methylamino)propyl (meth)acrylate, 2-(tert-butylamino)ethyl (meth)acrylate, 3-(tert-butylamino)propyl (meth)acrylate, 2-(dimethylamino)ethyl (meth)acrylamide, 3-(dimethylamino)propyl (meth)acrylamide, 2-(diethylamino)ethyl (meth)acrylamide, 3-(dimethylamino)propyl (meth)acrylamide, 2-(methylamino)ethyl (meth)acrylamide, 3-(methylamino)propyl (meth)acrylamide, 2-(ethylamino)ethyl (meth)acrylamide, 3-(ethylamino)propyl (meth)acrylamide, 2-(tert-butylamino)ethyl (meth)acrylamide, and 3-(tert-butylamino)propyl (meth)acrylamide. Vinyl amine may also represent a suitable monomer in some cases.

The foregoing second film-forming polymers may further comprise another type of ethylenically unsaturated monomer copolymerized with at least one acrylate monomer, such as those provided above. Alpha olefins may be used for this purpose. Suitable alpha olefins that may be present include, but are not limited to, ethylene, propylene, isobutylene, 1-butene, 1-pentene, 1-hexene, 4-methyl-1-pentene, 1-octene, 1-decene, 1-dodecene, 1-tetradecene, or any combination thereof. Linear alpha olefins having an even number of carbon atoms may be particularly suitable due to their ready commercial availability.

Other examples of monomers that may be copolymerized with at least one acrylate monomer include, for example, styrene or substituted variants thereof; divinyl benzenes; dienes such as 1,3-butadiene and isoprene; vinyl esters, such as vinyl acetate, vinyl alkanoates or their derivatives; nitriles such as (meth)acrylonitrile and fumaronitrile; (meth)acrylamides; and ethylenically unsaturated halides such as vinyl chloride and vinylidene chloride.

Ethylenically unsaturated monomers bearing at least one acidic group may also be present in combination with at least one acrylate monomer, such as those bearing a side chain carboxylic acid or sulfonic acid. Illustrative examples may include, but are not limited to, maleic acid, methyl hydrogen maleate, ethyl hydrogen maleate, itaconic acid, fumaric acid, crotonic acid, citraconic acid, styrenesulfonic acid, and 2-aminomethylpropanesulfonic acid derivatized with a vinyl group. Carboxylic acid forms of the foregoing monomers may be present in an esterified form as well, such as methyl, ethyl, propyl, isopropyl, butyl, isobutyl, t-butyl or like esterified form. Other suitable esterified monomers may comprise an ethylenically unsaturated group in the alcohol-derived portion of the esterified monomer. Such ethylenically unsaturated monomers may include, for example, vinyl acetate, allyl acetate, vinyl propionate, allyl propionate, vinyl benzoate, allyl benzoate, and the like.

In addition to the ethylenically unsaturated polymers and copolymers discussed above, polymers having other types of polymer backbones may also be suitable for use in the aqueous emulsions and coatings of the present disclosure as well. Exemplary polymer backbones suitable for use as film-forming polymers may include, but are not limited to, polyesters, polyamides, polyurethanes, polyethers, polyether sulfones, polyetherether ketones, polyimides, polyetherimides, polyetheresters, and the like. Optionally, a co-monomer to promote water-solubility or biodegradability may be included if needed to maintain a microplastics-free state. Rosins, gums, and natural oils may also be suitably used as alternatives to a film-forming polymer as well.

The aqueous emulsions disclosed herein may comprise a suitable plasticizer, which may be biodegradable or non-biodegradable in particular embodiments. Suitable examples for the plasticizer are not believed to be particularly limited, other than being dispersible in an aqueous emulsion of the present disclosure and being capable of promoting robust thin film formation when interacting with the shellac. A suitable plasticizer may also aid in conveying flexibility to the thin film in some cases. Some examples of suitable plasticizers may be derived from a biological source, although non-biologically sourced plasticizers may also be used. Specific examples of suitable plasticizers may include, but are not limited to, epoxidized soybean oil, epoxidized linseed oil, castor oil, tannic acid, milk proteins, polyethylene glycol, or any combination thereof. Still other examples of plasticizers may be suitable such as, for example, epoxidized sunflower oil, cardanol and modified cardanol, glycidol, chlorine- and phosphate-containing vegetable based plasticizers, phosphaphenanthrene-modified vegetable oils, hydroxyl- and nitrogen-group-containing tung oil esters, dimethyl oleate-based plasticizers, citric acid esters, and the like. Surprisingly, in addition to promoting robust thin film formation, inclusion of a suitable plasticizer in the aqueous emulsions disclosed herein may improve dry flow performance and decrease dust off once a coating has been formed. Preferably, a plasticizer may be omitted when the aqueous emulsions contain shellac particles.

If included, the plasticizer may be present in the aqueous emulsions described herein in an amount up to about 10 wt. %, or up to about 5 wt. %, or up to about 4 wt. %, or up to about 3 wt. %, or up to about 2 wt. %, or up to about 1 wt. %, such as about 0.1 wt. % to about 1.5 wt. %, or about 0.5 wt. % to about 2 wt. %, or about 0.7 wt. % to about 1.7 wt. %, or about 0.8 wt. % to about 2 wt. %, as measured based on the mass of total solids within the aqueous emulsion. The decision as to whether a plasticizer needs to be included may be based upon desired performance of a coating formed from the aqueous emulsions and whether a second film-forming polymer is present.

Additional components may be present in the aqueous emulsions disclosed herein such as one or more of, for example, effect pigments (colorants), dyes, optical brighteners, crosslinking agents, defoamers, anti-static agents, dispersants, thickeners, fillers, biocides, herbicides, rheology modifiers (e.g., hydrophobically modified ethoxylated polyurethanes and similar rheology-modifying polymers), fluency aids, lubricants, preservatives (e.g., benzoisothiazolinones, methylisothiazolinones, methylchloroisothaizolinones, and the like), coalescent aids, other emulsified polymers, buffers, co-solvents, surfactants, and any combination thereof. Such additional components may be present in amounts conventionally present in aqueous emulsions useful in coating applications. Other examples of additional components that may be present when the aqueous emulsions are utilized for forming a thin-film coating upon seeds may include, but are not limited to, fertilizers, nutrients, moisture modifiers, and the like. All of these additional components need not necessarily be present in a given aqueous emulsion or coating. Zero, one or more than one of each type of additional component may be present in any combination within the aqueous emulsions. For example, there may be at least one or more than one effect pigment, at least one or more than one crosslinking agent, and/or at least one or more than one surfactant. A crosslinking agent may be omitted in some embodiments. Suitable examples of these additional components will be familiar to persons having ordinary skill in the art of emulsion and coating technologies and will not be described in further detail herein.

When used, additional components may be selected independently from one another to modify one or more properties of the aqueous emulsions (e.g., to promote formation of a thin film) or to promote suitability for a given application. For example, when being utilized as a coating for seeds or other surface for which coloration is important, one or more effect pigments or dyes may be present within the aqueous emulsions. In other cases, such as when being used to form a primer coating upon other surfaces such as paper or cardboard, effect pigments, dyes, and other colorants may be optionally omitted. Crosslinking agents may be present or absent when forming a primer coating as well.

Illustrative surfactants that may be suitable for use in the aqueous emulsions disclosed herein are not believed to be particularly limited and may include any of cationic surfactants, anionic surfactants, neutral surfactants (non-ionic surfactants), zwitterionic surfactants, and any combination thereof. Suitable surfactants may be present in an amount up to about 20 wt. %, or up to about 15 wt. %, or up to about 10 wt. %, or up to about 8 wt. %, or up to about 5 wt. %, or up to about 4 wt. %, or up to about 3 wt. %, or up to about 2 wt. %, or up to about 1 wt. %, or up to about 0.5 wt. %, as measured based upon the mass of total solids in the aqueous emulsion. Illustrative non-ionic surfactants that may be suitable for use in the disclosure herein include, but are not limited to, alkylaryl polyether alcohols, alkylphenol ethoxylates, alkyl ethoxylates, polyoxamers, fatty acid esters (e.g., fatty acid glycerol esters, fatty acid sorbitan esters, fatty acid sorbitol esters, fatty acid lecithin esters, and the like), polyethylene oxide sorbitan fatty acid esters, and any combination thereof. Illustrative anionic surfactants that may be suitable for use in the disclosure herein include, but are not limited to, alkyl ethoxylate sulfates, alkyl ethoxylate sulfonates, alkylphenol ethoxylate sulfates, alkylphenol ethoxylate sulfonates, alkylsulfates, alkylsulfonates, alkylarylsulfates, alkylarylsulfonates, sulfosuccinates, and any combination thereof. Illustrative zwitterionic surfactants that may be suitable for use in the disclosure herein include various betaines and sultaines.

Any of the components within the aqueous emulsions and coatings formed therefrom may be optionally crosslinked, either with an organic crosslinking agent (e.g., an amine in the case of crosslinking an epoxide) or a metal atom that promotes crosslinking through chelation. Suitable examples of crosslinking agents that may promote crosslinking through chelation include, but are not limited to, zinc oxide, magnesium oxide, ammonium zirconium carbonate, and others, such as various transition metal compounds.

Types of surfaces upon which coatings may be formed using the aqueous emulsions of the present disclosure are not believed to be particularly limited, provided that there is adequate adhesion between the surface and the coating. In non-limiting examples, surfaces that may be coated using the aqueous emulsions include, but are not limited to, seeds, paper, cardboard and other types of packaging, wood (e.g., for architectural coatings), wood, metal (e.g., a metal can), other polymers (e.g., within polymer-based circuit board assemblies), and the like. Similarly, the aqueous emulsions described herein may be used to coat sizing upon fibers as well. When used to form a coating upon paper and other substrates in which the coating should be inconspicuous, the aqueous emulsions may be formulated to provide optical clarity once dried as a coating. For example, in the case of aqueous emulsions containing shellac particles, the size of the shellac particles may be selected to afford a coating having optical clarity. Additional details in this regard are provided above.

In more particular examples, the present disclosure provides coated seeds formed from the aqueous emulsions described herein. Such coated seeds may comprise a base seed, and a thin-film coating formed upon a surface of the base seed. In some embodiments, the thin-film coating may comprise an optional wax, and a polymer blend comprising shellac, a film-forming polymer that is water-soluble or biodegradable, and, optionally, a plasticizer. The shellac may be distributed throughout the thin-film coating in the form of shellac particles, such that the shellac particles and wax particles (if present) define a discontinuous phase within the thin-film coatings. The film-forming polymer may define a continuous phase in the thin-film coatings, in which the wax particles and the shellac particles are distributed. The wax particles and the shellac particles may be uniformly intermixed together with one another when defining the discontinuous phase. In some embodiments, the thin-film coating may lack the wax and comprise a polymer blend comprising shellac, a film-forming polymer that is water-soluble or biodegradable, and, optionally, a plasticizer. In such embodiments, the film-forming polymer may define a continuous phase in the thin-film coating in which the shellac particles are distributed as a discontinuous phase. In still other embodiments, the thin-film coating may comprise shellac particles, a film-forming polymer that is water-soluble or biodegradable, and optionally, a plasticizer and/or a wax. When present in a thin-film coating, the shellac particles may remain in particulate form within the thin-film coating. That is, the thin-film coating may contain a continuous phase comprising the film-forming polymer and a discontinuous phase comprising the shellac particles and optionally the wax particles (if present). The plasticizer may be present in any embodiment of a seed coating disclosed herein. Amounts and more specific examples of these components are provided above. Any of the other optional components described herein may be present within the thin-film coatings as well.

Optionally, the thin-film coatings may further comprise at least one effect pigment in the thin-film coating and/or at least one component of the thin-film coating may be further crosslinked. Components within the thin-film coatings that may be further crosslinked to themselves and/or to other components include, but are not limited to, the shellac, the film-forming polymer, the plasticizer, the wax, or any combination thereof. Examples of suitable crosslinking agents are provided above.

The thin-film coating upon a seed may have a coating weight of about 50 mL to about 200 mL per 45.4 kg of seed. Depending on the seed, the thin-film coating may have a thickness of about 0.5 microns to about 5.0 microns. Examples of seeds that may have a thin-film coating introduced thereto according to the present disclosure include, for example, cereals, vegetables, ornamentals, and fruits. More specific examples of seeds that may be coated according to the disclosure herein include, for instance, soybean seeds, corn seeds, cotton seeds, rice seeds, oat seeds, rye seeds, barley seeds, vegetable seeds, wheat seeds, sunflower seeds, lettuce seeds, spinach seeds, or the like.

Coating thicknesses of thin-film coatings formed upon other types of surfaces according to the present disclosure may range from about 1 μm to about 400 μm, or about 10 μm to about 100 μm, or about 50 μm to about 300 μm, or about 75 μm to about 225 μm. Coating thicknesses may be selected based on their suitability for a given application.

After formation of an aqueous emulsion in accordance with the disclosure above, methods of the present disclosure may further comprise disposing the aqueous emulsion upon a base substrate, such as a plurality of seeds, and removing aqueous fluid from the polymer emulsion (e.g., by evaporation) while upon the base substrate to form a thin-film coating disposed upon a surface of the base substrate. Optionally, crosslinking of one or more components within the thin-film coating may occur in the course of forming the thin-film coating upon the base substrate. Application of the aqueous emulsion to the base substrate may be achieved using any of a variety of methods such as, for example, immersion, spraying, rod or roller coating, tumbling, or through using equipment such as a size press, water box, blade coater, cast coater, rod coater, air knife coater, curtain coater, film press coater, flexo coater, the like, or any combination thereof. Beyond seeds, any other type of base substrate, such as cardboard, paper, wood, or metal (e.g., a metal can), for example, may be coated as well.

In non-limiting examples, the thin-film coating may be formed using a batch coater, a drum coater, or the like. In other non-limiting examples, the thin-film coating may be formed by spraying. The chosen coating method may depend on the particular type of seed or other type of surface to be coated.

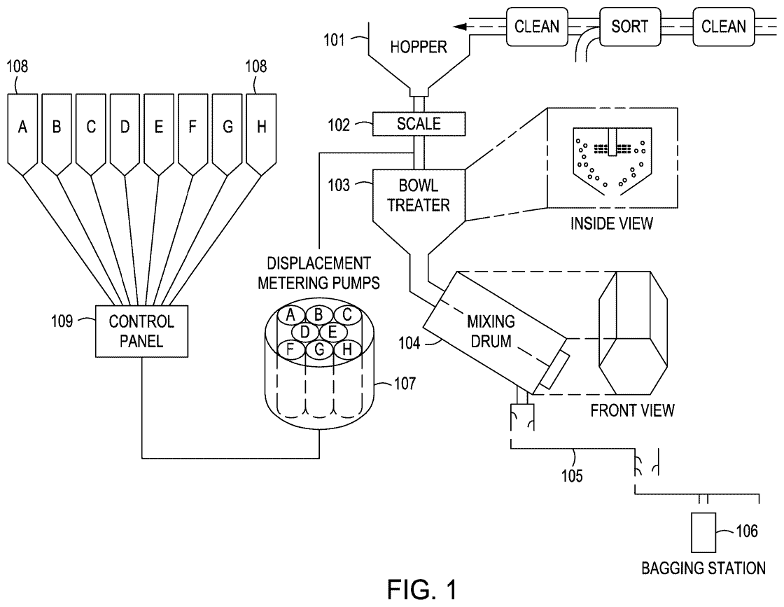

FIG. 1 is a diagram of an illustrative system for coating seeds using a drum coater according to various embodiments of the present disclosure. As shown in FIG. 1, seeds are cleaned, sorted, and added to supply hopper 101. The seeds flow through supply hopper 101 to scale 102 and into bowl treater 103. Supply hopper 101 and scale 102 control the rate of seed flow into bowl treater 103. In bowl treater 103, the seeds pass through a zone of sprayed or atomized coating material. The seeds then pass from bowl treater 103 into mixing drum 104.

Mixing drum 104 rotates the seeds and the seed coating components, thereby ensuring that each seed is substantially completely coated with the seed coating. Evaporation of the aqueous fluid may take place during the course of this process, thereby leaving the other components disposed upon the outer surface of the seed as the thin-film coating. Heating and/or application of vacuum may take place in some instances to promote more rapid evaporation of the aqueous fluid. The coated seeds then exit through an opening of mixing drum 104. Coated seeds exiting mixing drum 104 may contact one or more conveyor belts 105 which transport the seeds to bagging station 106.

The drum coater may include one or more of metering pump 107 that provides the aqueous emulsion to bowl treater 103. In particular, metering pump 107 draws the aqueous emulsion from one or more tanks 108 as directed by control panel 109.

It is to be appreciated that seed coatings having a composition as described herein need not necessarily be deposited from a single aqueous emulsion as defined above. That is, one or more components of the thin-film coating may be applied to a plurality of seeds, optionally in emulsified form, individually or together with an aqueous emulsion lacking those one or more components. Accordingly, the components that make up a thin-film coating upon a seed or other type of surface may be coated on the seed or other surface simultaneously or substantially simultaneously independent of whether or not they are mixed together in a single aqueous emulsion prior to coating. Alternately, the components of the thin-film coating may be applied to the seed or surface separately from one another at different times.

Although the foregoing has described one or more embodiments that feature spraying of an aqueous emulsion onto a plurality of seeds, it should be understood that any suitable coating process may be used. As but one example, the seeds may be directly mixed with the aqueous emulsion or a similar coating composition. In still other embodiments, the seeds may be tumbled with the aqueous emulsion, film coated, pelleted, encrusted, or the like. Other types of coatings, for example, may be formed by immersion (dip coating) of a suitable substrate in an aqueous emulsion and then removing solvent to form a coating upon the substrate.

Accordingly, coating methods for seeds according to the present disclosure may comprise: providing a plurality of seeds, contacting the plurality of seeds with an aqueous emulsion of the present disclosure, and removing the aqueous fluid to produce a plurality of coated seeds comprising a thin-film coating. In some embodiments, the thin-film coating may comprise a wax, and a polymer blend comprising shellac, a film-forming polymer that is water-soluble or biodegradable, and, optionally, a plasticizer, and in other embodiments, the wax may be omitted. When the shellac is dispersed in the aqueous emulsion such that the shellac is at least partially soluble in the aqueous phase, the shellac and the film-forming polymer may collectively define a continuous phase within the thin-film coating and the wax may be present as a discontinuous phase. In some embodiments, the thin-film coating may comprise shellac particles and a thin-film forming polymer that is water-soluble or biodegradable, in which a wax may optionally be present. When shellac particles are dispersed as emulsified solids in the aqueous emulsions, the film-forming polymer may define a continuous phase in the thin-film coating and the shellac particles (and wax particles, if present) may define a discontinuous phase (i.e., a particulate phase) distributed throughout the continuous phase. Optionally, any of these components may be further crosslinked with themselves or with one or more additional components once the thin-film coating has been formed upon a seed or other suitable coating surface. Removal of the aqueous fluid may comprise evaporation of the aqueous fluid from the surface of the seeds once the aqueous emulsion has been deposited upon the surface of the seeds, optionally assisted by application of heat and/or vacuum. Deposition of the aqueous emulsion upon the surface of the seeds may comprise spraying the aqueous emulsion onto the plurality of seeds, tumbling the aqueous emulsion with the plurality of seeds, or any combination thereof.

Embodiments disclosed herein include:

A. Aqueous emulsions. The polymer emulsions comprise: an aqueous fluid; a wax; and a polymer blend comprising shellac, a first film-forming polymer that is water-soluble or biodegradable, and, optionally, plasticizer; wherein the wax and the polymer blend are dispersed in the aqueous fluid.

A1. Aqueous emulsions comprising: an aqueous fluid; and a polymer blend comprising shellac, a first film-forming polymer that is water-soluble or biodegradable, and, optionally, plasticizer; wherein the wax and the polymer blend are dispersed in the aqueous fluid.

B. Coated substrates. The coated substrates comprise: a base substrate; and a thin-film coating formed upon a surface of the base substrate and comprising: a wax, and a polymer blend comprising shellac, a first film-forming polymer that is water-soluble or biodegradable, and, optionally, a plasticizer.

B1. Coated substrates. The coated substrates comprise: a base substrate; and a thin-film coating formed upon a surface of the base substrate and comprising: a polymer blend comprising shellac, a first film-forming polymer that is water-soluble or biodegradable, and, optionally, a plasticizer.

C. Coated seeds. The coated seeds comprise: a base seed; and a thin-film coating formed upon a surface of the base seed and comprising: a wax, and a polymer blend comprising shellac, a first film-forming polymer that is water-soluble or biodegradable, and, optionally, a plasticizer.

C1. Coated seeds. The coated seeds comprise: a base seed; and a thin-film coating formed upon a surface of the base seed and comprising: a polymer blend comprising shellac, a first film-forming polymer that is water-soluble or biodegradable, and, optionally, a plasticizer.

D. Coating methods. The coating methods comprise: providing a base substrate; contacting the base substrate with the aqueous emulsion of A or A1; and removing the aqueous fluid to produce a coated substrate comprising a thin-film coating comprising the wax, and the polymer blend comprising the shellac, the film-forming polymer that is water-soluble or biodegradable, and, optionally, the plasticizer.

D1. Seed coating methods. The seed coating methods comprise: providing a plurality of seeds; contacting the plurality of seeds with the aqueous emulsion of A or A1; and removing the aqueous fluid to produce a plurality of coated seeds comprising a thin-film coating comprising the wax, and the polymer blend comprising the shellac, the film-forming polymer that is water-soluble or biodegradable, and, optionally, the plasticizer.

E. Polymer blends. The polymer blends comprise shellac; a film-forming polymer that is water-soluble or biodegradable; and a plasticizer.

Each of embodiments A, A1, B, B1, C, C1, D, D1 and E may have one or more of the following additional elements in any combination:

Element 1: wherein the first film-forming polymer comprises a polyvinyl alcohol, a polylactic acid, a polyglycolic acid, or any combination thereof.

Element 2: wherein the first film-forming polymer comprises at least a polyvinyl alcohol.

Element 3: wherein the plasticizer is biodegradable.

Element 4: wherein the plasticizer comprises epoxidized soybean oil, castor oil, tannic acid, milk proteins, or any combination thereof.

Element 5: wherein the aqueous emulsion further comprises at least one effect pigment.

Element 5A: wherein the thin-film coating further comprises at least one effect pigment.

Element 6: wherein the aqueous emulsion further comprises at least one crosslinking agent.

Element 6A: wherein at least one component of the thin-film coating is further crosslinked.

Element 7: wherein the aqueous fluid contains about 10 wt. % to about 60 wt. % solids, based on total mass of the aqueous emulsion.

Element 8: wherein the aqueous emulsion further comprises a second film-forming polymer different from the first film-forming polymer, optionally wherein the second film-forming polymer comprises polyvinylpyrrolidone-co-polyvinylacetate.

Element 9: wherein the wax does not constitute a microplastic.

Element 10: wherein the aqueous emulsion further comprises at least one surfactant, at least one biocide, or any combination thereof.

Element 10A: wherein the thin-film coating further comprises one or more of: at least one surfactant, at least one biocide, or any combination thereof.

Element 11: wherein the plasticizer is present.

Element 12: wherein contacting comprises spraying the aqueous emulsion onto the plurality of seeds, or tumbling the plurality of seeds with the aqueous emulsion.

By way of non-limiting example, exemplary combinations applicable to A, A1, B, B1, C, C1, D, D1, and E include, but are not limited to, 1 or 2, and 3; 1 or 2, and 4; 1 or 2, and 5 or 5A; 1 or 2, and 6 or 6A; 1 or 2, 5 or 5A, and 6 or 6A; 1 or 2, and 7; 1 or 2, and 8; 1 or 2, and 9; 1 or 2, and 10 or 10A; 1 or 2, and 11; 3 and 4; 3, and 5 or 5A; 3, and 6 or 6A; 3, 5 or 5A, and 6 or 6A; 3 and 7; 3 and 8; 3 and 9; 3, and 10 or 10A; 3 and 11; 4, and 5 or 5A; 4, and 6 or 6A; 4, 5 or 5A, and 6 or 6A; 4 and 7; 4 and 8; 4 and 9; 4, and 10 or 10A; 4 and 11; 5 or 5A, and 6 or 6A; 5 or 5A, and 7; 5 or 5A, and 8; 5 or 5A, and 9; 5 or 5A, and 10 or 10A; 5 or 5A, and 11; 6 or 6A, and 7; 6 or 6A, and 8; 6 or 6A, and 9; 6 or 6A, and 10 or 10A; 6 or 6A, and 11; 7 and 8; 7 and 9; 7, and 10 or 10A; 7 and 11; 8 and 9; 8, and 10 or 10A; 8 and 11; 9, and 10 or 10A; 9 and 11; and 10 and 11. Any of the foregoing may be in further combination with 14, or any one of 1, 2, 3, 4, 5, 5A, 6, 6A, 7, 8, 9, 10, 10A, or 11 alone.

Additional embodiments disclosed herein include:

A′. Aqueous emulsions. The polymer emulsions comprise: an aqueous fluid; a film-forming polymer that is water-soluble or biodegradable; optionally, a plasticizer; and shellac particles dispersed in solid form in the aqueous fluid.

B′. Coated substrates. The coated substrates comprise: a base substrate; and a thin-film coating formed upon a surface of the base substrate and comprising: a film-forming polymer that is water-soluble or biodegradable, shellac particles, and optionally, a plasticizer.

C′. Coated seeds. The coated seeds comprise: a base seed; and a thin-film coating formed upon a surface of the base seed and comprising: a film-forming polymer that is water-soluble or biodegradable, shellac particles, and optionally, a plasticizer.

D′. Coating methods. The coating methods comprise: providing a base substrate; contacting the base substrate with the aqueous emulsion of A; and removing the aqueous fluid to produce a coated substrate comprising a thin-film coating comprising the film-forming polymer and the shellac particles.

D1′. Seed coating methods. The seed coating methods comprise: providing a plurality of seeds; contacting the plurality of seeds with the aqueous emulsion of A; and removing the aqueous fluid to produce a plurality of coated seeds comprising a thin-film coating comprising the film-forming polymer and the shellac particles.

Each of embodiments A′, B′, C′, D′, and D1′ may have one or more of the following additional elements in any combination:

Element 1′: wherein the film-forming polymer comprises a polyvinyl alcohol, a polylactic acid, a polyglycolic acid, or any combination thereof.

Element 2′: wherein the film-forming polymer comprises at least a polyvinyl alcohol.

Element 3′: wherein the plasticizer, if present, comprises epoxidized soybean oil, epoxidized linseed oil, polyethylene glycol, castor oil, tannic acid, milk proteins, or any combination thereof.

Element 4′: wherein the aqueous emulsion further comprises at least one effect pigment.

Element 4A′: wherein the thin-film coating further comprises at least one effect pigment.

Element 5′: wherein the aqueous emulsion further comprises at least one wax.

Element 5A′: wherein the thin-film coating further comprises at least one wax.

Element 6′: wherein the aqueous emulsion contains about 10 wt. % to about 60 wt. % solids, based on total mass of the aqueous emulsion.

Element 7′: wherein the aqueous emulsion contains about 30 wt. % to about 70 wt. % shellac particles, based on total mass of solids.

Element 7A′: wherein the thin-film coating comprises about 30 wt. % to about 70 wt. % shellac particles, based on total mass of the thin-film coating.

Element 8′: wherein the aqueous emulsion contains about 20 wt. % to about 60 wt. % film-forming polymer, based on total mass of solids.

Element 8A′: wherein the thin-film coating comprises about 20 wt. % to about 60 wt. % first film-forming polymer, based on total mass of the thin-film coating.

Element 9′: wherein the aqueous emulsion further comprises at least one surfactant, at least one biocide, at least one preservative, at least one second film-forming polymer, at least one crosslinking agent, or any combination thereof.

Element 9A′: wherein at least one component of the thin-film coating is further crosslinked.

Element 9B′: wherein the thin-film coating further comprises one or more of: at least one surfactant, at least one biocide, at least one preservative, at least one second thin-film forming polymer, or any combination thereof.

Element 10′: wherein the shellac particles have an average particle size ranging from about 50 nm to about 5000 nm.

Element 11′: wherein contacting comprises spraying the aqueous emulsion onto the plurality of seeds, or tumbling the plurality of seeds with the aqueous emulsion.

By way of non-limiting example, exemplary combinations applicable to A′, B′, C′, D′, and D1′ include, but are not limited to, 1′ or 2′, and 3′; 1′ or 2′, and 4′ or 4A′; 1′ or 2′, and 5′ or 5A′; 1′ or 2′, and 6′; 1′ or 2′, and 7′ or 7A′; 1′ or 2′, and 8′ or 8A′; 1′ or 2′, and 9′, 9A′, or 9B′; 1′ or 2′, and 10′; 4′ or 4A′, and 5′ or 5A′; 4′ or 4A′, and 6′; 4′ or 4A′, and 7′ or 7A′; 4′ or 4A′, and 8′ or 8A′; 4′ or 4A′, and 9′, 9A′, or 9B′; 4′ or 4A′, and 10′; 5′ or 5A′, and 6′; 5′ or 5A′, and 7′ or 7A′; 5′ or 5A′, and 8′ or 8A′; 5′ or 5A′, and 9′, 9A′, or 9B′; 5′ or 5A′, and 10′; 7′ or 7A′, and 8′ or 8A′; 7′ or 7A′, and 9′, 9A′, or 9B′; 7′ or 7A′, and 10′; 8′ or 8A′, and 9′, 9A′, or 9B′; 8′ or 8A′, and 10′; and 9′, 9A′, or 9B′, and 10′. Any of the foregoing may be in further combination with 11′.

The present disclosure is further directed to the following non-limiting clauses.
Clause 1. An aqueous emulsion comprising:
   an aqueous fluid;
   a film-forming polymer that is water-soluble or biodegradable, the film-forming polymer being at least partially dissolved in the aqueous fluid;
   optionally, a plasticizer; and
   shellac particles dispersed in solid form in the aqueous fluid.
Clause 2. The aqueous emulsion of clause 1, wherein the film-forming polymer comprises a polyvinyl alcohol, a polylactic acid, a polyglycolic acid, a polysaccharide, or any combination thereof.
Clause 3. The aqueous emulsion of clause 1, wherein the film-forming polymer comprises at least a polyvinyl alcohol.
Clause 4. The aqueous emulsion of any one of clauses 1-3, wherein the plasticizer, if present, comprises epoxidized soybean oil, epoxidized linseed oil, polyethylene glycol, castor oil, tannic acid, milk proteins, or any combination thereof.
Clause 5. The aqueous emulsion of any one of clauses 1-3, further comprising:
   at least one effect pigment.
Clause 6. The aqueous emulsion of any one of clauses 1-3, further comprising:
   at least one wax.
Clause 7. The aqueous emulsion of clause 6, wherein the aqueous emulsion contains about 10 wt. % to about 60 wt. % solids, based on total mass of the aqueous emulsion.
Clause 8. The aqueous emulsion of any one of clauses 1-3, wherein the aqueous emulsion contains about 10 wt. % to about 60 wt. % solids, based on total mass of the aqueous emulsion.
Clause 9. The aqueous emulsion of any one of clauses 1-3, wherein the aqueous emulsion contains about 30 wt. % to about 70 wt. % shellac particles, based on mass of total solids.
Clause 10. The aqueous emulsion of any one of clauses 1-3, wherein the aqueous emulsion contains about 20 wt. % to about 60 wt. % film-forming polymer, based on mass of total solids.
Clause 11. The aqueous emulsion of any one of clauses 1-3, further comprising one or more of:
   at least one surfactant, at least one biocide, at least one preservative, at least one second film-forming polymer, at least one crosslinking agent, or any combination thereof.
Clause 12. The aqueous emulsion of any one of clauses 1-3, wherein the shellac particles have an average particle size ranging from about 50 nm to about 5000 nm.
Clause 13. A coated seed comprising:
   a base seed; and
   a thin-film coating formed upon a surface of the base seed and comprising:
      a film-forming polymer that is water-soluble or biodegradable, shellac particles, and optionally, a plasticizer.
Clause 14. The coated seed of clause 13, wherein the film-forming polymer comprises a polyvinyl alcohol, a polylactic acid, a polyglycolic acid, a polysaccharide, or any combination thereof.
Clause 15. The coated seed of clause 13, wherein the plasticizer, if present, comprises epoxidized soybean oil, epoxidized linseed oil, polyethylene glycol, castor oil, tannic acid, milk proteins, or any combination thereof.
Clause 16. The coated seed of any one of clauses 13-15, wherein the thin-film coating further comprises at least one effect pigment.
Clause 17. The coated seed of any one of clauses 13-15, wherein at least one component of the thin-film coating is further crosslinked.
Clause 18. The coated seed of any one of clauses 13-15, wherein the thin-film coating further comprises one or more of:
   at least one surfactant, at least one biocide, at least one preservative, at least one second thin-film forming polymer, or any combination thereof.
Clause 19. The coated seed of any one of clauses 13-15, wherein the thin-film coating further comprises at least one wax.
Clause 20. The coated seed of any one of clauses 13-15, wherein the thin-film coating comprises about 30 wt. % to about 70 wt. % shellac particles, based on total mass of the thin-film coating.
Clause 21. The coated seed of any one of clauses 13-15, wherein the thin-film coating comprises about 20 wt. % to about 60 wt. % first film-forming polymer, based on total mass of the thin-film coating.
Clause 22. The coated seed of any one of clauses 13-15, wherein the shellac particles have an average particle size ranging from about 50 nm to about 5000 nm.
Clause 23. A method comprising:
   providing a plurality of seeds;
   contacting the plurality of seeds with the aqueous emulsion of any one of clauses 1-3; and
   removing the aqueous fluid to produce a plurality of coated seeds comprising a thin-film coating comprising the film-forming polymer, and the shellac particles, and, optionally, the plasticizer.
Clause 24. The method of clause 23, wherein contacting comprises spraying the aqueous emulsion onto the plurality of seeds, or tumbling the plurality of seeds with the aqueous emulsion.
Clause 25. The method of clause 23, wherein the plasticizer is present.
Clause 26. The method of clause 23, wherein the shellac particles are distributed as a discontinuous phase within the thin-film coating.

To facilitate a better understanding of the disclosure herein, the following examples of various representative embodiments are given. In no way should the following examples be read to limit, or to define, the scope of the present disclosure.

### EXAMPLES

### Formulations Containing Dissolved Shellac

An experimental polymer blend (Polymer Blend #1) was formulated with the following composition (wt. % with respect to total mass of the polymer blend): shellac (66%), polyvinyl alcohol (19%), polyvinyl acetate-polyvinyl pyrollidone copolymer (8%), epoxidized soybean oil plasticizer (4%), and deionized water (3%). The polymer blend was then mixed with additional water and further components as specified in Table 1 below for Samples 1-4. Rice bran wax was used in most instances, although carnauba wax and Fischer-Tropsch waxes were also tested. The shellac was present in dissolved form following emulsification.

A first comparative polymer blend (Polymer Blend #2) was formulated identically to Polymer Blend #1, except the epoxidized soybean oil plasticizer was omitted. In this case, the composition was as follows (wt. % with respect to total mass of the polymer blend): shellac (69%), polyvinyl alcohol (20%), polyvinyl acetate copolymer (8%), and water (3%). The first comparative polymer blend was then mixed with additional water and further components as specified in Table 2 below for Samples 5-8 (all comparative samples). The shellac was present in dissolved form following emulsification.

TABLE 1

| | Sample 1 | Sample 2 | Sample 3 | Sample 4 |
|---|---|---|---|---|
| | (wt. % by total mass) | | | |
| Wax | 25 | 24 | 25 | 22 |
| Polymer Blend | 32 | 31 | 32 | 31 |
| Water | 14 | 12 | 15 | 17 |
| Pigment(s) | 19 | 19 | 19 | 19 |
| Dispersant | 0.3 | 0.3 | 0.3 | 0.3 |
| Wetting Agent | 0.2 | 0.2 | 0.2 | 0.2 |
| Rheology Modifier | 0.3 | 0.3 | 0.3 | 0.3 |
| Biocide | 0.1 | 0.1 | 0.1 | 0.1 |
| Defoamer | 0.1 | 0.1 | 0.1 | 0.1 |
| Anti-Freeze Agent | 6 | 6 | 6 | 6 |
| Further Additives | 3 | 7 | 2 | 4 |
| Total | 100 | 100 | 100 | 100 |

TABLE 2

| | Sample 5 | Sample 6 | Sample 7 | Sample 8 |
|---|---|---|---|---|
| | (wt. % by total mass) | | | |
| Wax | 27.5 | 27 | 28 | 29 |
| Polymer Blend | 30.7 | 30 | 32 | 32 |
| Water | 12 | 12 | 11 | 10 |
| Pigment(s) | 19 | 18 | 17 | 14 |
| Dispersant | 0.3 | 0.3 | 0.3 | 0.3 |
| Wetting Agent | 0.3 | 0.2 | 0.2 | 0.2 |
| Rheology Modifier | 0.1 | 0.3 | 0.3 | 0.3 |
| Biocide | 0.1 | 0.1 | 0.1 | 0.1 |
| Defoamer | 0.1 | 0.1 | 0.1 | 0.1 |
| Anti-Freeze Agent | 6 | 6 | 6 | 6 |
| Further Additives | 3.9 | 6 | 5 | 8 |
| Total | 100 | 100 | 100 | 100 |

A second set of comparative samples was prepared similarly by substituting only synthetic polymer for the shellac/polyvinyl alcohol/epoxidized soybean oil blend, as specified in Table 3 below.

TABLE 3

| | |
|---|---|
| Sample 9 | Sample 10 |

(wt. % by total mass)

| | | |
|---|---|---|
| Wax | 18 | 17 |
| Synthetic Polymer | 27 | 26 |
| Water | 11 | 10 |
| Pigment(s) | 31 | 30 |
| Dispersant | 2.7 | 2.6 |
| Wetting Agent | 0.9 | 0.9 |
| Rheology Modifier | 0.05-0.1 | 0.05-0.1 |
| Biocide | 0.2 | 0.2 |
| Defoamer | 0.1 | 0.1 |
| Further Additives | 9 | 13 |
| Total | 100 | 100 |

### Formulations Containing Shellac Particles

Polyvinyl Alcohol Preparation: A first intermediate solution was prepared using dewaxed shellac having an acid value of 68-72 (equivalents of acid groups/g shellac). The acid number was determined by titrating a 20 wt. % solution of shellac in ethanol with a standardized base. The first intermediate solution was prepared by combining the dewaxed shellac with a volatile base, such as aqueous ammonia, until an aqueous solution was formed. A second intermediate solution was prepared by dissolving polyvinyl alcohol in deionized water at 18 wt. % total solids.

The second intermediate solution was heated to 50° C. with stirring. The first intermediate solution was then added to the second intermediate solution portion-wise over about 5 minutes while keeping the temperature at about 80° C. or below. 50 wt. % citric acid aqueous solution was added dropwise to the combined reaction over while maintaining stirring with a high-shear mixer. After addition of the citric acid was complete, stirring was continued for an additional 1-2 minutes. In the present example, the shellac particles formed at a pH above 7, and the final pH was adjusted to 5.2 before further use. Average particle sizes (D₅₀) of the precipitated shellac particles are specified in the further data below. The rate of stirring and the addition rate of citric acid addition may be utilized to vary the size of the shellac particles. After shellac particle formation was complete, the dispersion was cooled to 25° C. and stirring, if any, was conducted by hand or with a low-shear mixer. Defoamer and/or additional citric acid were added as needed to maintain a stable dispersion having a pH of approximately 5.

Polyvinyl Alcohol-Free Preparation: A 25 wt. % solution of shellac in ethanol was diluted 1:1 with deionized water. To the diluted solution was then added solid Clariant 4106 fatty alcohol ethoxylate non-ionic surfactant to provide a final surfactant concentration of 5 wt. %. Upon dissolution of the surfactant, 50 wt. % citric acid in water was added to afford a final citric acid concentration of 1 wt. % in the diluted solution. The resulting shellac particle dispersion after acidification had an average shellac particle size of 92 nm. The corresponding D₉₀ and D₉₉ values were 139 nm and 178 nm, respectively.

Seed Coating Procedure. Aqueous emulsions prepared as above (Tables 1-3 and shellac particle emulsions) were then coated onto corn or soybean seeds using standard seed coating procedures. In brief, 10 grams of the aqueous emulsion was contacted with 1 kg of seeds in a standard seed coating apparatus. After 30 seconds of contact, the seeds were recovered from the seed coater and allowed to dry 18-24 hours.

Once the coating had dried upon the surfaces of the individual seeds, further testing was performed to evaluate dry flow and dust formation (dust off) performance of the coated seeds. For measuring dry flow performance, 400 g of seeds were placed in the seed flow meter. Flow was measured as the mass of seeds that flowed through the meter in 0.4 seconds. Dividing the mass by the flow time provided the reported dry flow rates. Dry flow measurements were conducted 8 times, and the results were averaged. For Heubach dust off performance, 100 g of seeds were placed in a Heubach dust off apparatus, along with a pre-weighed filter. After 300 cycles of rotation, the seeds and the filter were each weighed. The mass collected on the filter was utilized to determine the reported dust off values.

### Seed Coatings and Other Data for Formulations Containing Dissolved Shellac

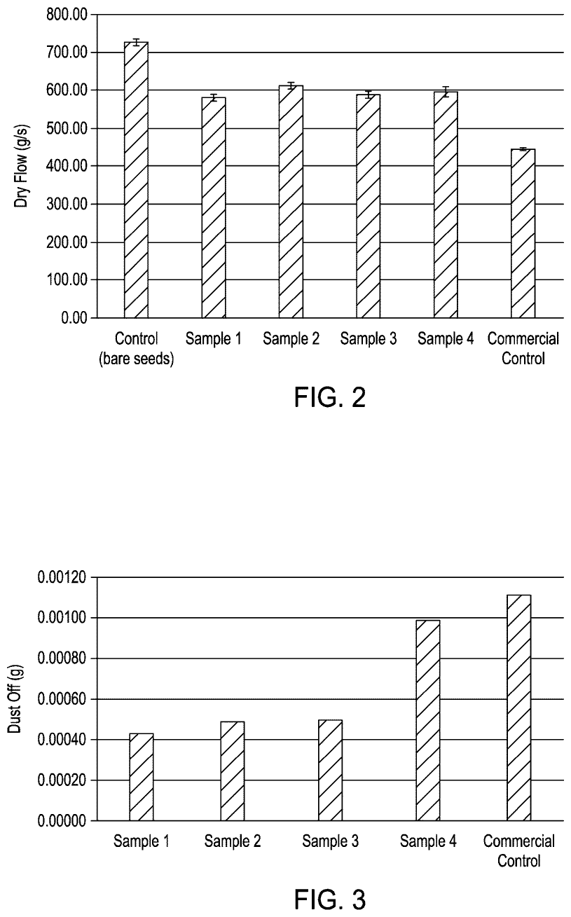

FIG. 2 is a plot of dry flow performance of seeds coated using the aqueous emulsions of Samples 1-4. As shown, minor variations in the amounts of additional components in the aqueous emulsions resulted in only negligible variation of the dry flow performance. The dry flow performance of the experimental coatings was slightly better (higher) than that afforded by a commercial coating formulation containing microplastics but slightly lower than that of uncoated seeds.

FIG. 3 is a plot of Heubach dust off performance of seeds coated using the aqueous emulsions of Samples 1-4. The values are reported as absolute mass difference after 5 minutes of run time. As shown, Sample 4 afforded comparable dust off performance to that of a commercial control. Samples 1-3 afforded superior (lower) dust off values compared to the commercial control.

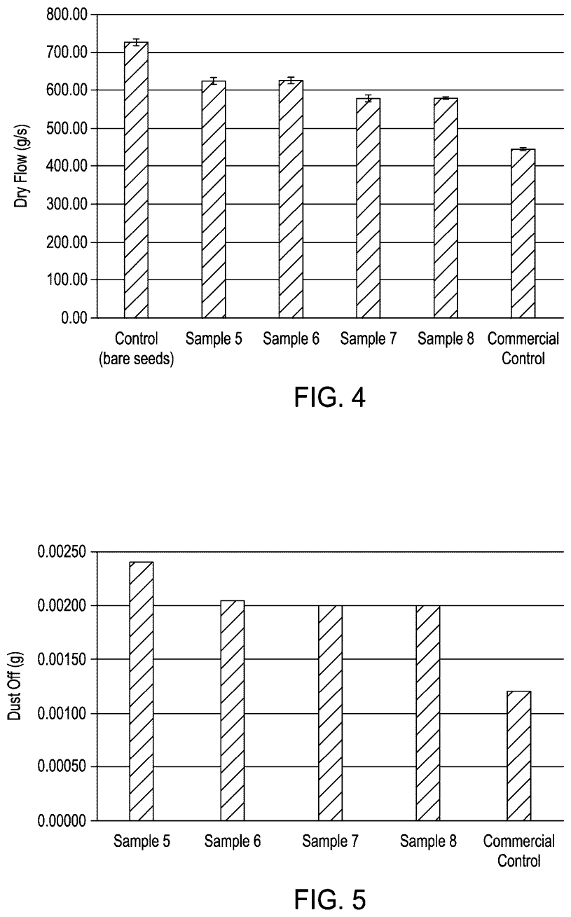

When the epoxidized soybean oil plasticizer was omitted from the samples, somewhat poorer dust control performance was realized. FIG. 4 is a plot of dry flow performance of seeds coated with the aqueous emulsions of Samples 5-8. As shown, dry flow values increased when the plasticizer was omitted and were higher than the commercial control. FIG. 5 is a plot of Heubach dust off performance of seeds coated using the aqueous emulsions of Samples 5-8. Although better dry flow performance was realized when omitting the plasticizer, dust off values were poorer for coated seeds lacking the plasticizer. In addition, coatings lacking the plasticizer were more brittle than those obtained when the plasticizer was present.

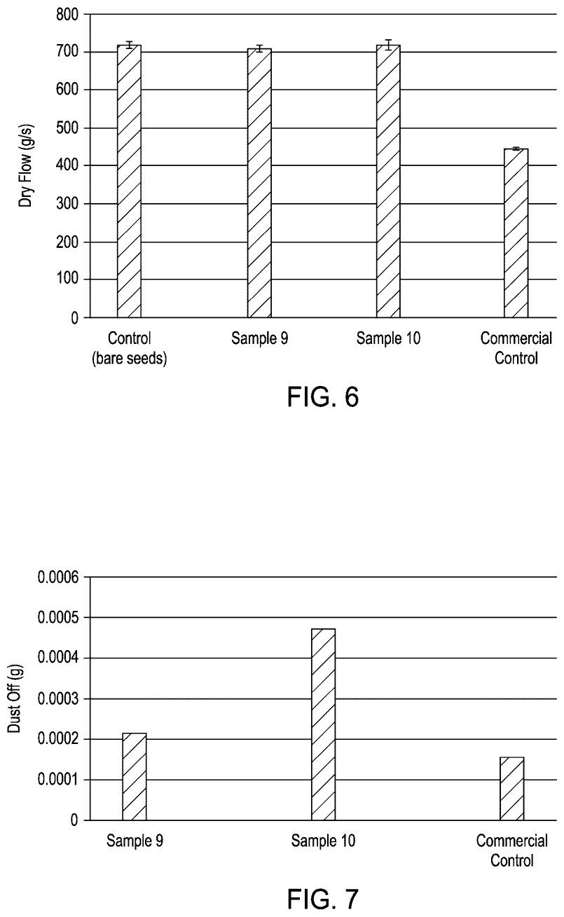

When the shellac/polyvinyl alcohol/epoxidized soybean oil blend was replaced by a synthetic polymer, comparable or slightly better dry flow and dust off performance was realized in comparison to the samples containing the shellac/polyvinyl alcohol/epoxidized soybean oil blend. However, samples lacking the shellac/polyvinyl alcohol/epoxidized soybean oil blend are not free of microplastics. FIG. 6 is a plot of dry flow performance of seeds coated with the aqueous emulsions of Samples 9 and 10. FIG. 7 is a plot of Heubach dust off performance of seeds coated using the aqueous emulsions of Samples 9 and 10.

Samples replacing all or part of the polyvinyl alcohol or polyvinyl acetate copolymer with functionalized biopolymers, such as carboxymethyl cellulose or hydroxypropyl methylcellulose, exhibited thixotropic rheology and high viscosity and were not readily coated upon seeds (data not shown).

### Seed Coating and Other Data for Formulations Containing Shellac Particles

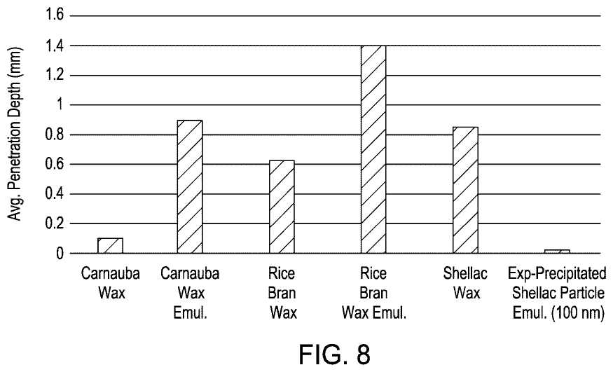

Hardness of the shellac particles was determined by evaporating the solvent from an aqueous emulsion described above to form a solid mass. Other waxes or wax dispersions were similarly formed into a solid mass for comparative measurements. Hardness was determined based upon penetration depth of a needle forced into the solid mass under a 150 g load. FIG. 8 is a graph showing average penetration depth for various types of wax in comparison to shellac particles. The shellac particles tested in this example were about 100 nm in size and were prepared from a polyvinyl alcohol solution, as specified above. Needle penetration depths were usually greater for test samples formed from an aqueous emulsion. Without being bound by theory or mechanism, the emulsifier in the aqueous emulsions reduces the hardness and density of the test sample, thereby increasing the needle penetration depth. In the case of shellac dispersions, the hardness of shellac itself results in a very low needle penetration depth. As shown, the shellac particles exhibited a considerably lower penetration depth than did various types of waxes, including carnauba wax, a commonly used wax in aqueous coating formulations.

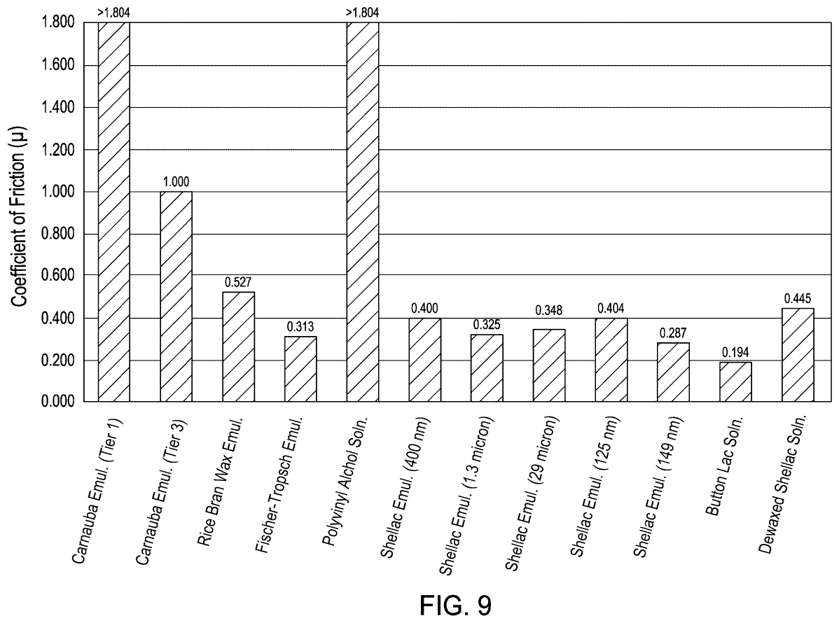

The coefficient of friction of coatings formed from shellac particles was measured in comparison to coatings formed from various types of waxes. The coefficient of friction (μ) was determined using a slide angle tester equipped with a 750 gram sled. The coatings were formed by depositing an aqueous emulsion containing wax particles or shellac particles upon a paper substrate and evaporating solvent from the emulsion to form a 10 mil thick layer. FIG. 9 is a graph showing coefficient of friction for various types of coatings in comparison to coatings containing shellac particles of various sizes. The shellac-containing coatings in FIG. 9 were prepared from a polyvinyl alcohol-based emulsion, as specified above. As shown, coatings containing shellac particles of various sizes in combination with polyvinyl alcohol exhibited comparable coefficient of friction values to waxes commonly used in coatings, but a much lower coefficient of friction than did the polyvinyl alcohol itself. Coatings containing shellac particles but lacking polyvinyl alcohol exhibited considerably higher coefficient of friction values. For example, for the polyvinyl alcohol-free shellac particle dispersion prepared as above, the coefficient of friction value was 1.072 (data not shown in FIG. 9), a value still comparable to that of a Tier 3 carnauba wax.

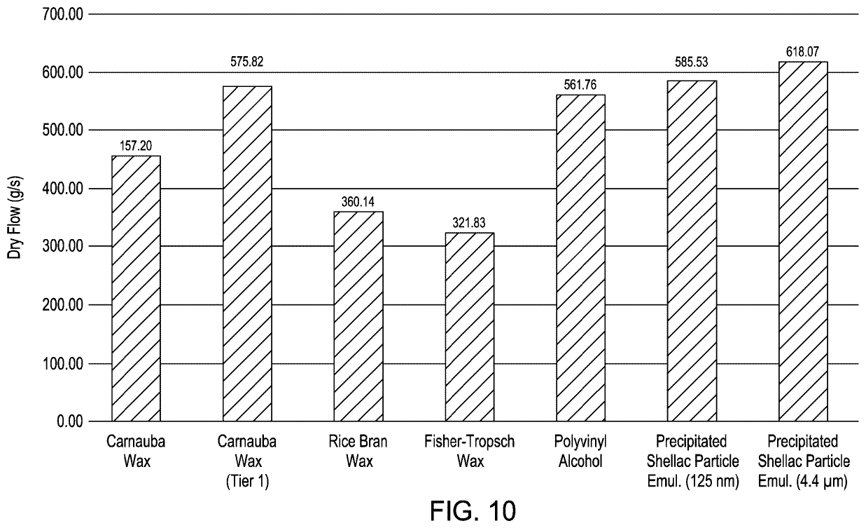

FIG. 10 is a graph of dry flow performance of seeds coated with conventional wax coatings in comparison to seeds coated with shellac particles of various sizes. The shellac particles had a mean particle size (D₅₀) of 125 nm, 1.25 μm, or 4.4 μm and were deposited from an aqueous emulsion also containing polyvinyl alcohol. As shown in FIG. 10, the shellac particles afforded dry flow performance comparable to that of other wax coatings.

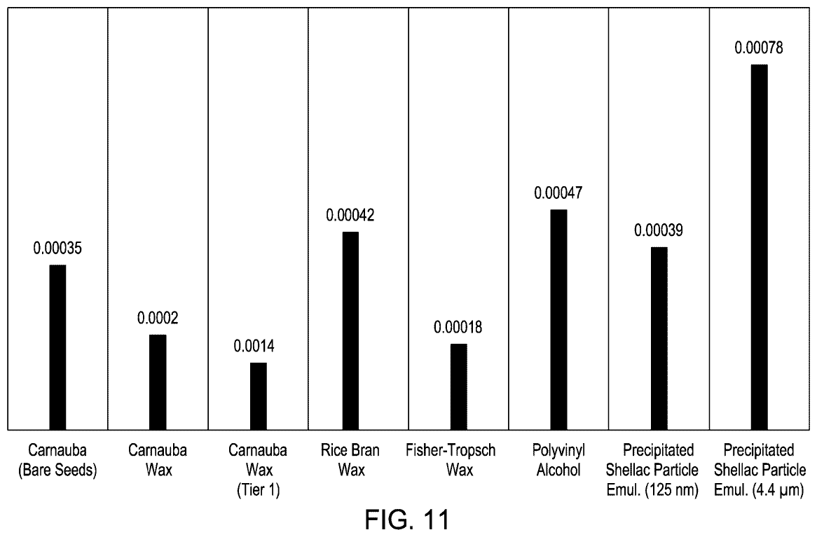

FIG. 11 is a plot of Heubach dust off performance of seeds coated with conventional wax coatings in comparison to shellac particles of various sizes. Again, the shellac particles were deposited from an aqueous emulsion also containing polyvinyl alcohol. The values in FIG. 11 are reported as absolute mass difference after 5 minutes of run time. As shown, seeds coated using an aqueous emulsion containing smaller shellac particles afforded better (lower) dust off values than did coated seeds containing larger shellac particles. The dust off performance was comparable to that of conventional wax coatings.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. An aqueous emulsion comprising:
an aqueous fluid;
a film-forming polymer that is water-soluble or biodegradable, the film-forming polymer being at least partially dissolved in the aqueous fluid;
optionally, a plasticizer; and
shellac particles dispersed in solid form in the aqueous fluid.

2. The aqueous emulsion of claim 1, wherein the film-forming polymer comprises a polyvinyl alcohol, a polylactic acid, a polyglycolic acid, a polysaccharide, or any combination thereof.

3. (canceled)

4. The aqueous emulsion of claim 1, wherein the plasticizer, if present, comprises epoxidized soybean oil, epoxidized linseed oil, polyethylene glycol, castor oil, tannic acid, milk proteins, or any combination thereof.

5. The aqueous emulsion of claim 1, further comprising:
at least one effect pigment.

6. The aqueous emulsion of claim 1, further comprising:
at least one wax.

7. (canceled)

8. The aqueous emulsion of claim 1, wherein the aqueous emulsion contains about 10 wt. % to about 60 wt. % solids, based on total mass of the aqueous emulsion.

9. The aqueous emulsion of claim 1, wherein the aqueous emulsion contains about 30 wt. % to about 70 wt. % shellac particles, based on mass of total solids.

10. The aqueous emulsion of claim 1, wherein the aqueous emulsion contains about 20 wt. % to about 60 wt. % film-forming polymer, based on mass of total solids.

11. The aqueous emulsion of claim 1, further comprising one or more of:
at least one surfactant, at least one biocide, at least one preservative, at least one second film-forming polymer, at least one crosslinking agent, or any combination thereof.

12. The aqueous emulsion of claim 1, wherein the shellac particles have an average particle size ranging from about 50 nm to about 5000 nm.

13. A coated seed comprising:
a base seed; and
a thin-film coating formed upon a surface of the base seed and comprising:
a film-forming polymer that is water-soluble or biodegradable, shellac particles, and optionally, a plasticizer.

14. The coated seed of claim 13, wherein the film-forming polymer comprises a polyvinyl alcohol, a polylactic acid, a polyglycolic acid, a polysaccharide, or any combination thereof.

15. The coated seed of claim 13, wherein the plasticizer, if present, comprises epoxidized soybean oil, epoxidized linseed oil, polyethylene glycol, castor oil, tannic acid, milk proteins, or any combination thereof.

16. The coated seed of claim 13, wherein the thin-film coating further comprises at least one effect pigment.

17. The coated seed of claim 13, wherein at least one component of the thin-film coating is further crosslinked.

18. The coated seed of claim 13, wherein the thin-film coating further comprises one or more of:
at least one surfactant, at least one biocide, at least one preservative, at least one second thin-film forming polymer, or any combination thereof.

19. The coated seed of claim 13, wherein the thin-film coating further comprises at least one wax.

20. The coated seed of claim 13, wherein the thin-film coating comprises about 30 wt. % to about 70 wt. % shellac particles, based on total mass of the thin-film coating.

21. The coated seed of claim 13, wherein the thin-film coating comprises about 20 wt. % to about 60 wt. % film-forming polymer, based on total mass of the thin-film coating.

22. The coated seed of claim 13, wherein the shellac particles have an average particle size ranging from about 50 nm to about 5000 nm.

23. A method comprising:
providing a plurality of seeds;
contacting the plurality of seeds with the aqueous emulsion of claim 1; and
removing the aqueous fluid to produce a plurality of coated seeds comprising a thin-film coating comprising the film-forming polymer, and the shellac particles, and, optionally, the plasticizer.

24. The method of claim 23, wherein contacting comprises spraying the aqueous emulsion onto the plurality of seeds, or tumbling the plurality of seeds with the aqueous emulsion.

25. The method of claim 23, wherein the plasticizer is present.

26. The method of claim 23, wherein the shellac particles are distributed as a discontinuous phase within the thin-film coating.
